(19) United States
(12) Patent Application Publication
(10) Pub. No.: US 2025/0238686 A1
(43) Pub. Date: Jul. 24, 2025

(54) METHOD AND SYSTEM FOR IDENTIFYING ENTITY TAGGING ERROR OF KNOWLEDGE GRAPH ON LITERATURE DATA SET

(71) Applicant: HANGZHOU CITY UNIVERSITY, Hangzhou (CN)

(72) Inventors: Zhaoyan MING, Hangzhou (CN); Shizhuang LIU, Hangzhou (CN); Minghui WU, Hangzhou (CN)

(21) Appl. No.: 18/259,546

(22) PCT Filed: Nov. 1, 2022
(86) PCT No.: PCT/CN2022/128851

§ 371 Date: Mar. 13, 2025

(30) Foreign Application Priority Data
Jul. 18, 2022 (CN) 202210839625.1

(51) Int. Cl. G06N 5/022; G06F 40/117

(52) U.S. Cl. CPC G06N 5/022; G06F 40/117

(57) ABSTRACT

The present invention offers a method for identifying entity tagging errors in knowledge graphs on literature datasets. It involves data preprocessing on tagged literature data, selecting pre-training models with SentencePiece tokenizers, and establishing deep learning network models for training. Throughout the training, models and parameters are recorded and saved as candidate critic models. Based on accuracy, 2k models are chosen as critic models with trusted parameters, where k represents the number of selected pre-training models. A voting mechanism is used to select disputed entities in the literature data set using critic models. The top n entities with text coincidence degrees exceeding a preset threshold are identified, scored according to coincidence degree and frequency, and entities with scores below the discrimination threshold are determined as incorrect.

### FIELD

The present invention relate to the technical field of computer natural language processing, and in particular, to a method and system for identifying an entity tagging error of a knowledge graph on a literature data set.

### BACKGROUND

A knowledge graph has been proved to be effective in modeling structured information and conceptual knowledge. Constructing a knowledge graph usually requires two tasks: named entity recognition (NER) and relation extraction (RE). The named entity recognition refers to identifying named entities from literature data, and the relation extraction refers to extracting an association relationship between entities from a series of discrete named entities, and connecting entities by using relationships to form a mesh knowledge network. High-quality entity tagging information is a key step to construct the knowledge graph, and ensuring accuracy of entity recognition is the basis of relation extraction. However, it is not easy to maintain a data set and ensure accuracy of entity tagging information therein under the background of increasingly large databases in various fields.

### SUMMARY

Based on the above background, the present invention provides a method for identifying an entity tagging error of a knowledge graph on a literature data set, which can be used to build a high-quality knowledge graph in professional fields.

Specifically, the following technical solutions are used.

In a first aspect of the present invention, a method for identifying an entity tagging error of a knowledge graph on a literature data set is provided, including the following steps:
S1: performing data preprocessing on a literature data set subjected to entity tagging;
S2: selecting a preset number of pre-training models using SentencePiece tokenizers;
S3: establishing, based on the selected pre-training models, a corresponding number of deep learning network models for training, and recording and saving models and parameters during the entire training as to-be-selected critic models;
S4: selecting, based on model accuracy, 2k models from the to-be-selected critic models as critic models, and setting trusted parameters for the critic models, wherein k is the number of the selected pre-training models;
S5: selecting, based on a voting mechanism, disputed entities from the knowledge graph on a literature data set by using the selected critic models; and
S6: searching for, in the literature data set, top n entities whose text information coincidence degrees with the disputed entities exceed a preset coincidence degree threshold, scoring the disputed entities according to the coincidence degree and a frequency, and determining disputed entities whose scores are less than a discrimination threshold as incorrect entities.

Further, in step S1, the data preprocessing includes processing an entity nesting problem in the literature data set, and specifically includes converting a conventional BIO label into a machine reading comprehension label format, which includes a context, whether an entity is contained, an entity label, an entity start position, an entity end position, a text identifier, an entity identifier qas_id, and a query.

Further, in step S2, the pre-training model of the SentencePiece tokenizer includes XLNet, ELMo, ROBERTa and ALBERT models.

Further, step S3 specifically includes:
S31: loading each pre-training model by using BertModel and BertPreTrainedModel modules to form a plurality of upstream neural networks;
S32: inputting preprocessed data to the plurality of upstream neural networks to obtain semantic representations of a plurality of contexts, and then setting a plurality of downstream neural networks corresponding to the upstream neural networks by using a plurality of fully connected layers, to form a plurality of deep learning network models; and
S33: recording and saving parameters learned by each epoch of each deep learning network model, and obtaining models and parameters during the entire training as to-be-selected critic models.

Further, in step S4, a calculation formula of the trusted parameter is:

$$T = Softmax ( {P}_{1} , {P}_{2} , … , {P}_{2 k} )$$

where Pᵢ is accuracy of an i^{th} critic model, and T is the trusted parameter. Further, step S5 specifically includes:
S51: inputting each entity tag of the literature data set into the critic models, to obtain entity tags inconsistent with the label, and denoting as disputed entities to be voted on; and
S52: Voting on, based on the trusted parameter of each critic model, the disputed entities to be voted on, and selecting disputed entities based on a preset score threshold, wherein the trusted parameter of each critic model is the number of votes for each entity.

Further, step S6 specifically includes:
S61: searching for, in the literature data set, top n entities whose text information coincidence degrees with the disputed entities exceed the preset coincidence degree threshold as query entities;
S62: scoring the disputed entities according to a coincidence degree Dᵢ and an entity frequency Fᵢ corresponding to the n query entities, as well as a frequency μ of the disputed entities in the literature data set, with a scoring calculation method as follows:

$${Score}_{i} = {F}_{i} / μ \times {D}_{i} , i = ( 1 , 2 , … , n ) ;$$

S63: calculating for n times to obtain a score set (Score₁, Score₂, . . . , Scoreₙ) corresponding to the disputed entities, and if any score in the score set is less than the discrimination threshold, determining the disputed entity as an incorrect entity.

Further, the method according to the present invention further includes:
S0: collecting literature data in a specific field to form a literature data set, and performing entity tagging on the literature data set, specifically including: cutting an entire article into text fragments with a length less than 256 characters, and manually performing entity tagging on each text fragment by using a BIO tagging method.

In a second aspect of the present invention, a system for identifying an entity tagging error of a knowledge graph on a literature data set is provided, including:
a data preprocessing module, configured to perform data preprocessing on a literature data set subjected to entity tagging;
a pre-training model configuration module, configured to select a preset number of pre-training models using SentencePiece tokenizers;
a model training module, configured to establish, based on the selected pre-training models, a corresponding number of deep learning network models for training, and record and save models and parameters during the entire training as to-be-selected critic models;
a critic model generation module, configured to select, based on model accuracy, 2k models from the to-be-selected critic models as critic models, and set trusted parameters for the critic models, where k is the number of the selected pre-training models;
a disputed entity selection module, configured to select, based on a voting mechanism, disputed entities from a literature data set by using the selected critic models; and
an error search module, configured to search for, in the literature data set, top n entities whose text information coincidence degrees with the disputed entities exceed a preset coincidence degree threshold, score the disputed entities according to the coincidence degree and a frequency, and determine disputed entities whose scores are less than a discrimination threshold as incorrect entities.

Further, the system further includes:
a tag generation module, configured to perform entity tagging on the literature data set composed of collected literature data in a specific field, specifically comprising: cutting an entire article into text fragments with a length less than 256 characters, and manually performing entity tagging on each text fragment by using a BIO tagging method.

The present invention has the beneficial effects that a method and corresponding system for identifying an entity tagging error of a knowledge graph on a literature data set are originally provided. In the method and system, named entity recognition and machine reading comprehension in the field of natural language processing are combined to solve the entity nesting problem that often occurs in the literature data set, a unique data set maintenance method is proposed for the first time, that is, training results of a plurality of deep learning models and two parameter models thereof with the highest accuracy are reserved as “critics” for determining whether there are errors in the data set, and a method for setting a trusted parameter is proposed. This ensures that the “critics” have different credibility and familiarity with semantic information of text during error correction, and ensures that there are a sufficient number of “critics”. The method and corresponding system according to the present invention perform well on a literature data set DiaKG in the medical field. In addition, the method can be well extended to other literature data sets, so as to construct high-quality knowledge graphs in various fields more efficiently.

### DESCRIPTION OF THE FIGURES

FIG. 1 is a basic schematic flowchart of a method embodiment of the present invention; and

FIG. 2 is a specific schematic flowchart of a shown embodiment of the present invention.

### DETAILED DESCRIPTION

To further understand the present invention, preferred implementation solutions of the present invention are described below with reference to embodiments, but it should be understood that these descriptions are only intended to further illustrate the features and advantages of the present invention, and are not intended to limit the claims of the present invention.

The present invention focuses on the named entity recognition and error correction in a task of constructing a knowledge graph of a literature data set. In the field of natural language processing, there is usually no problem of entity nesting in the conventional named entity recognition. However, in a literature data set in a professional field, a case that a piece of text contains a plurality of entities usually occurs. In addition, abbreviations of domain-specific words and expressions are difficult to look up in dictionaries, and a Chinese literature database often has the problem of mixed Chinese and English. Therefore, during description of the present invention, the above problems are encountered with by default, and the method used can solve the above problems, and is also applicable to literature databases without these problems.

Deep learning has a wide range of application scenarios, such as computer vision, natural language processing, speech analysis and other fields. According to the present invention, cutting-edge deep learning pre-training models, such as XLNet, ROBERTa, ALBERT are used, and a multi-model “voting” error correction method is proposed for the first time, which reduces time costs and labor costs of data tagging. It should be noted that when the solutions of the present invention are implemented, the selection of deep learning pre-training models is not necessarily limited to those listed in the present invention, and professionals can pay attention to latest pre-training models published in the field of deep learning according to their own needs, to select models suitable for their own data sets. The design of each hyper-parameter in the description may also be modified to some extent based on the professionals' own understanding of the problem.

In the field of deep learning, some technologies and methods have been made very modular, so it is understandable for those skilled in the art to omit some well-known structures and their descriptions in the accompanying drawings.

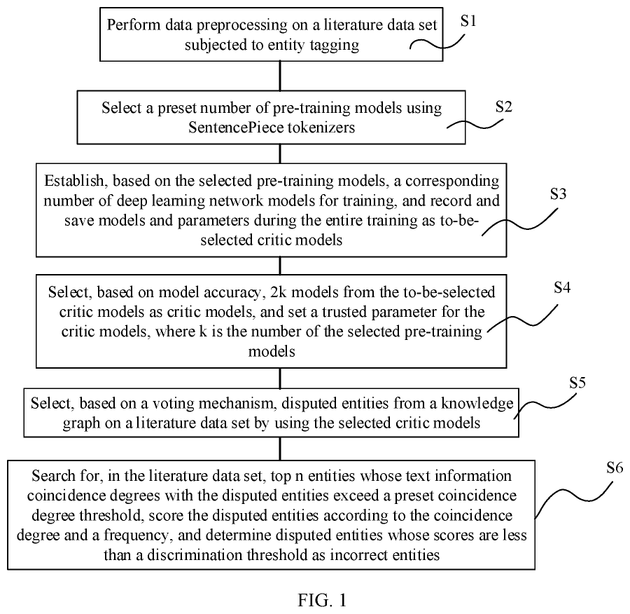

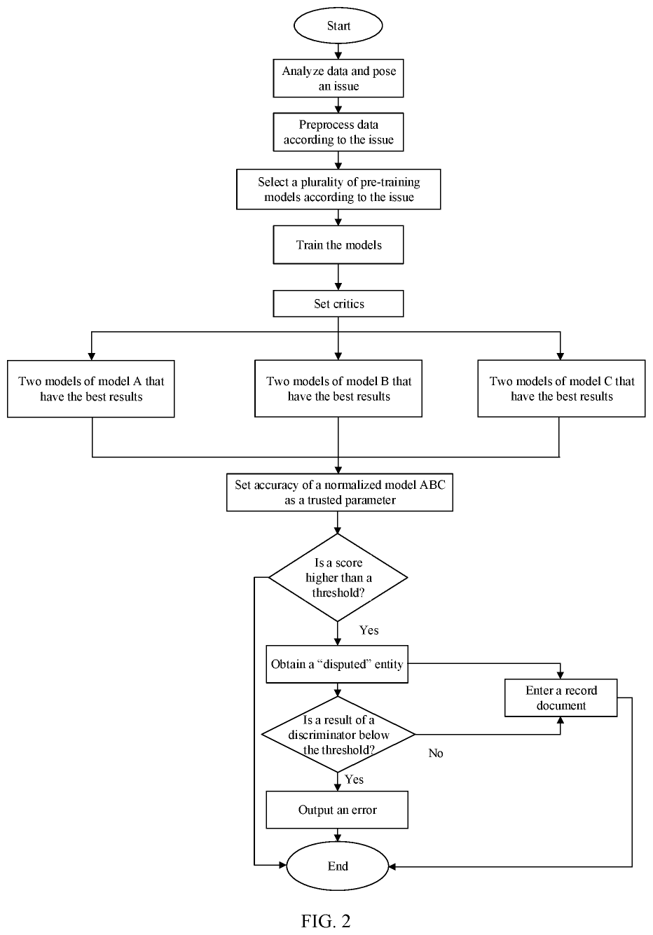

The method and corresponding system according to the present invention will be further described in detail with reference to FIG. 1 and FIG. 2 and specific embodiments.

Referring to FIG. 1 and FIG. 2, in a shown embodiment, a method for identifying an entity tagging error of a knowledge graph on a literature data set includes the following steps.
First step: Collect and establish a diabetes literature data set DiaKG in the medical field. The data set comes from 41 diabetes guidelines and consensus, all from authoritative Chinese journals, covering the most extensive research contents and hot-spot fields in recent years, including clinical research, drug use, clinical cases, diagnosis and treatment methods, etc. Text information therein is tagged, specifically: An entire article is cut into text fragments with a length less than 256 characters, and entity tagging is performed on each text fragment by AI experts and domain experts by using a BIO tagging method, to form a literature data set subjected to entity tagging.

It should be noted that the above steps are only used to give an example of generating a literature data set subjected to entity tagging, and are not necessary steps of the present invention. The method according to the present invention is suitable for all literature data sets that are generated by similar means or other means and have been subjected to entity tagging.
Second step: Perform data preprocessing on a literature data set subjected to entity tagging.

Taking the above diabetes literature data set DiaKG in the medical field as an example, the data set contains 22,050 entities in total, with categories as follows: “Disease”, “Class”, “Reason”, “Pathogenesis”, “Symptom”, “Test”, “Test_items”, “Test_Value”, “Drug”, “Total”, “Frequency”, “Method”, “Treatment”, “Operaction”, “ADE”, “Anatomy”, and “Level”.

Entities are nested with each other. With regard to “type 2 diabetes”, “type 2 diabetes” is an entity in the category of “Disease” and “type 2” is an entity in the category of “Class”. It can be found that two different categories of entities appear in the same piece of text. This case is referred to as entity nesting, which is very common in literature data sets and is a problem that must be faced with.

In addition, in this data set, there are many domain-specific sentences and English abbreviations. For example, “HbA1c” is in the category of “Test_items”, and refers to the glycosylated hemoglobin test in the medical field. It is difficult for researchers not in the medical field to know the meaning of the word, and there is no vocabulary exactly corresponding to this word.

Therefore, the entity nesting problem in literature data sets needs to be preprocessed. Entity nesting is solved by machine reading comprehension, and a conventional named entity recognition BIO label is converted into a machine reading comprehension label format, which includes a context, whether an entity is contained, an entity label entity_label, an entity start position start_position, an entity end position end position, an identifier qas_id and a query.

In the above data set example, if there are 17 entity categories in total, 17 queries are set for each contextual text fragment. The query mainly helps a machine to establish the query range and determine whether there are related entities in this text fragment. In addition, the query contains text information, which can help a model to converge faster.

For the setting of the query, reference may be made to Wikipedia, or the query may be set according to the researchers' own understanding of the data set. For example, for the entity “Disease”, the query is set as “Does the following contain the description of the disease, such as type 1 diabetes or type 2 diabetes”. A specific preprocessing format is shown in Table 1 below:

TABLE 1

| context | start_position | end_position | entity_label | impossible | qas_id | query |
|---|---|---|---|---|---|---|
| The second blood | [ ] | [ ] | Disease | true | 0.1 | Whether a |
| draw should be | | | | | | description of |
| performed 2 hours | | | | | | disease is |
| after taking sugar, | | | | | | included. |
| and a blood sample | | | | | | |
| is taken from the | | | | | | |
| forearm to measure | | | | | | |
| the blood sugar | | | | | | |
| (timing starts from | | | | | | |
| the first bite of sugar | | | | | | |
| to 2 hours, to obtain | | | | | | |
| 2 hPG). | | | | | | |
| The second blood | [22,42] | [23,45] | Test_items | false | 0.7 | Whether a |
| draw should be | | | | | | description of |
| performed 2 hours | | | | | | test item is |
| after taking sugar, | | | | | | included. |
| and a blood sample | | | | | | |
| is taken from the | | | | | | |
| forearm to measure | | | | | | |
| the blood sugar | | | | | | |
| (timing starts from | | | | | | |
| the first bite of sugar | | | | | | |
| to 2 hours, to obtain | | | | | | |
| 2 hPG). | | | | | | |

Since in the text “the second blood draw should be performed 2 hours after taking sugar, and a blood sample is taken from the forearm to measure the blood sugar (timing starts from the first bite of sugar to 2 hours, to obtain 2 hPG)”, there is no entity “Disease”, in the setting about “entity_label=“Disease”, start_position=[ ], end_position=[ ], and impossible=true.

Since there is an entity about “Test_items” in the text, impossible-false, impossible can help the machine quickly filter out unimportant data and save time during training, and the specific composition of qas_id is “text id”+“.”+“entity id”. After the preprocessing is completed, when a data set is sent to the deep learning neural network for training, the query and the context are combined into the format of [CLS]+query+[SEP]+context+[SEP], and the labels are start position and end position. This method may store all possible entity labels of a piece of text information, thereby effectively solving the entity nesting problem.
Third step: Select a preset number of pre-training models using SentencePiece tokenizers.

Tagged input data is obtained after data preprocessing. It is found that there are many English abbreviations of professional terms in the diabetes literature data set in the medical field, which leads to the fact that Chinese literature data set is mixed in Chinese and English, such as “2hPG” in the above context. In a usual BERT vocabulary, these words may be mapped to such an unknown word identifier “unknown”.

Therefore, a pre-training model using a SentencePiece tokenizer, such as ROBERTa, ALBERT, XLNet and ELMo, should be used. A BPE vocabulary at this byte level has the advantage of being able to encode any input text, so that no unknown word appears.

ROBERTa, ALBERT and XLNet are briefly described herein, to provide some ideas for technicians implementing the present invention to choose a model. ROBERTa introduces a dynamic mask technology on the basis of BERT, that is, a method for determining the position of the mask [MASK] is to perform calculation in real time in a model training stage, and this pre-training model refers to more data for training. To solve the problem of too large parameters during training, ALBERT introduces word vector parameter factorization, that is, hidden layer dimension≠word vector dimension, and the word vector dimension is reduced by adding a fully connected layer. In addition, more complex sentence order prediction (SOP) is introduced to replace a next sentence prediction (NSP) task in conventional BERT, which enables the pre-training model to learn more subtle semantic differences and discourse coherence. XLNet uses Transformer-XL as a main body frame, and uses a two-way autoregressive language model structure, that is, inputting one character and outputting a predicted next character, which can avoid the problem that conventional BERT introduces artificial [MASK].
Fourth step: Establish, based on the selected pre-training models, a corresponding number of deep learning network models for training, and record and save models and parameters during the entire training as to-be-selected critic models.

After the preprocessed data is obtained and the pre-training models are selected, BertModel and BertPreTrainedModel modules are imported from a transformers package to load each selected pre-training models, to form a plurality of upstream neural networks. Then, the preprocessed data is inputted to the plurality of upstream neural networks to obtain semantic representations of a plurality of contexts, and then a plurality of downstream neural networks corresponding to the upstream neural networks are set by using a plurality of fully connected layers, to form a plurality of deep learning network models. Finally, parameters learned by each epoch of each deep learning network model are recorded and saved, and models and parameters during the entire training are obtained as to-be-selected critic models.

In this step, the data passes through the upstream neural networks to obtain text semantic information, and then the data is sent to the downstream networks. Finally, the entity start position start_prediction and end position end_prediction are outputted by using two fully connected layers respectively. Losses are calculated by using labels start_position and end position and label masks start_position_mask and end_position_mask, and start loss and end loss are obtained by using a BCEWithLogitsLoss module in pytorch. Different weights may be set for start loss and end loss respectively. Herein, 0.5 and 0.5 are used as reference, that is, the start position and the end position have the same weight during loss calculation, and a formula for calculating a total loss total loss is obtained:

$$start\_loss = BCEWithLogitsLoss ( start\_prediction , start\_position ) * start\_position \_mask$$

$$end\_loss = BCEWithLogitsLoss ( end\_prediction , end\_position ) * end\_position \_mask$$

$$total\_loss = ( start\_loss + end\_loss ) / 2$$

Certainly, semantic information learned by the same pre-training model is different in different rounds; and semantic information learned by different pre-training models is also different. Therefore, each pre-training model should be trained once separately, and two models with the highest accuracy are reserved.
Fifth step: Select, based on model accuracy, 2k models from the to-be-selected critic models as critic models, and set trusted parameters for the critic models, where k is the number of the selected pre-training models.

In this example, six “critics” are set, and two models with the highest accuracy are selected as “critics” from training results with RoBERTa, ALBERT and XLNet as pre-training models respectively. According to the accuracy [P₁, P₂, P₃, P₄, P₅, P₆], different trusted parameters are set by using softmax, which ensures that when data with incorrect prediction is evaluated, a better trained model indicates a greater influence. In this example, a calculation formula of the trusted parameter is:

$$T = Soft max ( {P}_{1} , {P}_{2} , … , {P}_{2 k} )$$

where Pᵢ is accuracy of an i^{th} critic model, and T is the trusted parameter.
Sixth step: Select, based on a voting mechanism, disputed entities from a literature data set by using the selected critic models.

Each entity tag of the literature data set is inputted into the critic models first, to obtain entity tags inconsistent with the label, which are denoted as disputed entities to be voted on. Then, based on the trusted parameter of each critic model, voting is performed on the disputed entities to be voted on, and disputed entities are selected based on a preset score threshold, where the trusted parameter of each critic model is the number of votes for each entity.

In this example, six critic models “vote” on entities, and the trusted parameter of each critic model is the “number of votes” for each entity. A voting object of each critic model is an entity whose prediction result is inconsistent with a label result, and entities whose final scores are greater a set threshold are referred to as “disputed” entities. In practice, when the threshold is set to 3.5, the performance is the best, 93% of incorrect entities can be found, and a case that excessive pieces are generated, leading to a too long discrimination time for a discriminator is avoided.
Seventh step: Search for, in the literature data set, top n entities whose text information coincidence degrees with the disputed entities exceed a preset coincidence degree threshold, score the disputed entities according to the coincidence degree and a frequency, and determine disputed entities whose scores are less than a discrimination threshold as incorrect entities.

In the literature data set, first searching for top n entities whose text information coincidence degrees with the disputed entities exceed the preset coincidence degree threshold is performed, and the n entities are used as query entities. Then the disputed entities are scored according to a coincidence degree Dᵢ and an entity frequency Fᵢ corresponding to the n query entities, as well as a frequency μ of the disputed entities in the literature data set, with a scoring calculation method as follows: Scoreᵢ=Fᵢ/μ×Dᵢ, i=(1, 2, . . . , n). Finally, calculation is performed for n times to obtain a score set (Score₁, Score₂, . . . , Scoreₙ) corresponding to the disputed entities, and if any score in the score set is less than the discrimination threshold, the disputed entity is determined as an incorrect entity.

Specifically, in this example, entities with the highest dispute degree selected by the critic models are obtained and recorded. In this case, these entities are only “disputed” entities, in which there are still many entities with correct labels but determined as being incorrect due to a limited model ability. Therefore, further screening is needed. In this step, the time complexity of the discriminator used is (n×total×log (length)), where n is the number of “disputed” entities, total is the number of all data pieces, and length is the length of a single piece of data. Therefore, the design of the threshold should be noted in the previous step, and the threshold should not be set too low lest that the time for a discrimination link is too long. According to text information of the “disputed” entities, the discriminator searches for top five entities in the data set whose text information coincidence degrees with the disputed entities are greater than 90%. If there are less than five entities, only entities whose coincidence degrees are greater than 90% are selected. According to a coincidence degree D, a frequency F of entities whose coincidence degrees are greater than 90% and a frequency μ of the “disputed” entities in the data set, scoring is performed by using the above scoring calculation formula, to obtain min (num, 5) score results, where num is the number of entities whose coincidence degrees are greater than 90%. In practice, the score <0.045, which means that the “disputed” entities do not conform to the convention in the entire data set. In the experiment, the discriminant accuracy of the discriminator is as high as 98%.

During implementation of the method according to the present invention, after incorrect entities are identified, AI experts and domain experts can further review and modify errors on the original data set to obtain a more accurate data set.

Another embodiment of the present invention further provides a system for identifying an entity tagging error of a knowledge graph on a literature data set, including:
a tag generation module, configured to perform entity tagging on the literature data set composed of collected literature data in a specific field, specifically comprising: cutting an entire article into text fragments with a length less than 256 characters, and manually performing entity tagging on each text fragment by using a BIO tagging method.
a data preprocessing module, configured to perform data preprocessing on a literature data set subjected to entity tagging;
a pre-training model configuration module, configured to select a preset number of pre-training models using SentencePiece tokenizers;
a model training module, configured to establish, based on the selected pre-training models, a corresponding number of deep learning network models for training, and record and save models and parameters during the entire training as to-be-selected critic models;
a critic model generation module, configured to select, based on model accuracy, 2k models from the to-be-selected critic models as critic models, and set trusted parameters for the critic models, where k is the number of the selected pre-training models;
a disputed entity selection module, configured to select, based on a voting mechanism, disputed entities from a literature data set by using the selected critic models; and
an error search module, configured to search for, in the literature data set, top n entities whose text information coincidence degrees with the disputed entities exceed a preset coincidence degree threshold, score the disputed entities according to the coincidence degree and a frequency, and determine disputed entities whose scores are less than a discrimination threshold as incorrect entities.

For the specific implementation of each module in the above system, reference may be made to each step in the above method embodiment, and detailed description is not provided herein.

In the application of the above system, the original data set is constantly improved and corrected in the cycles of error entity recognition and manual review by using the system. Therefore, training results of each model in the system become increasingly good, and thus found error entities become increasingly accurate. During this period, hyper-parameters of the models in the system can be adjusted to set more stringent discriminators.

After using the method and the corresponding system of the present invention, researchers do not need to repeatedly check an entire literature data set piece by piece to implement error correction, but only need to wait for the output of specific incorrect entities by the system and then confirm the modification of the data set, thereby reducing the burden of maintaining entities of a knowledge graph on a huge literature data set.

The description of the foregoing embodiments is only used to help understand the method according to the present invention and a core idea thereof. It should be noted that a person of ordinary skill in the art can further make some improvements and modifications to the present invention without departing from the principles of the present invention, and these improvements and modifications shall also fall within the protection scope of the claims of the present invention.

1. A method for identifying an entity tagging error of a knowledge graph on a literature data set, comprising the following steps:
S1: performing data preprocessing on a literature data set subjected to entity tagging;
S2: selecting a preset number of pre-training models using SentencePiece tokenizers;
S3: establishing, based on the selected pre-training models, a corresponding number of deep learning network models for training, and recording and saving models and parameters during the entire training as to-be-selected critic models;
S4: selecting, based on model accuracy, 2k models from the to-be-selected critic models as critic models, and setting trusted parameters for the critic models, wherein k is the number of the selected pre-training models;
S5: selecting, based on a voting mechanism, disputed entities from the knowledge graph on a literature data set by using the selected critic models; and
S6: searching for, in the literature data set, top n entities whose text information coincidence degrees with the disputed entities exceed a preset coincidence degree threshold, scoring the disputed entities according to the coincidence degree and a frequency, and determining disputed entities whose scores are less than a discrimination threshold as incorrect entities.

2. The method for identifying an entity tagging error of a knowledge graph on a literature data set according to claim 1, wherein in step S1, the data preprocessing comprises processing an entity nesting problem in the literature data set, and specifically comprises converting a conventional BIO label into a machine reading comprehension label format, which comprises a context, whether an entity is contained, an entity label, an entity start position, an entity end position, a text identifier, an entity identifier qas_id, and a query.

3. The method for identifying an entity tagging error of a knowledge graph on a literature data set according to claim 1, wherein in step S2, the pre-training model of the SentencePiece tokenizer comprises XLNet, ELMo, ROBERTa and ALBERT models.

4. The method for identifying an entity tagging error of a knowledge graph on a literature data set according to claim 1, wherein step S3 specifically comprises:
S31: loading each pre-training model by using BertModel and BertPreTrainedModel modules to form a plurality of upstream neural networks;
S32: inputting preprocessed data to the plurality of upstream neural networks to obtain semantic representations of a plurality of contexts, and then setting a plurality of downstream neural networks corresponding to the upstream neural networks by using a plurality of fully connected layers, to form a plurality of deep learning network models; and
S33: recording and saving parameters learned by each epoch of each deep learning network model, and obtaining models and parameters during the entire training as to-be-selected critic models.

5. The method for identifying an entity tagging error of a knowledge graph on a literature data set according to claim 1, wherein in step S4, a calculation formula of the trusted parameter is:
$$T = Soft max ( {P}_{1} , {P}_{2} , … , {P}_{2 k} )$$
wherein Pᵢ is accuracy of an i^{th} critic model, and T is the trusted parameter.

6. The method for identifying an entity tagging error of a knowledge graph on a literature data set according to claim 1, wherein step S5 specifically comprises:
S51: inputting each entity tag of the literature data set into the critic models, to obtain entity tags inconsistent with the label, and denoting as disputed entities to be voted on; and
S52: Voting on, based on the trusted parameter of each critic model, the disputed entities to be voted on, and selecting disputed entities based on a preset score threshold, wherein the trusted parameter of each critic model is the number of votes for each entity.

7. The method for identifying an entity tagging error of a knowledge graph on a literature data set according to claim 1, wherein step S6 specifically comprises:
S61: searching for, in the literature data set, top n entities whose text information coincidence degrees with the disputed entities exceed the preset coincidence degree threshold as query entities;
S62: scoring the disputed entities according to a coincidence degree Dᵢ and an entity frequency Fᵢ corresponding to the n query entities, as well as a frequency μ of the disputed entities in the literature data set, with a scoring calculation method as follows:
$${Score}_{i} = {F}_{i} / μ \times {D}_{i} , i = ( 1 , 2 , … , n ) ;$$
S63: calculating for n times to obtain a score set (Score₁, Score₂, . . . , Scoreₙ) corresponding to the disputed entities, and if any score in the score set is less than the discrimination threshold, determining the disputed entity as an incorrect entity.

8. The method for identifying an entity tagging error of a knowledge graph on a literature data set according to any one of claims 1 to 7, further comprising:
S0: collecting literature data in a specific field to form a literature data set, and performing entity tagging on the literature data set, specifically comprising: cutting an entire article into text fragments with a length less than 256 characters, and manually performing entity tagging on each text fragment by using a BIO tagging method.

9. A system for identifying an entity tagging error of a knowledge graph on a literature data set, comprising:
a data preprocessing module, configured to perform data preprocessing on a literature data set subjected to entity tagging;
a pre-training model configuration module, configured to select a preset number of pre-training models using SentencePiece tokenizers;
a model training module, configured to establish, based on the selected pre-training models, a corresponding number of deep learning network models for training, and record and save models and parameters during the entire training as to-be-selected critic models;
a critic model generation module, configured to select, based on model accuracy, 2k models from the to-be-selected critic models as critic models, and set trusted parameters for the critic models, where k is the number of the selected pre-training models;
a disputed entity selection module, configured to select, based on a voting mechanism, disputed entities from a literature data set by using the selected critic models; and
an error search module, configured to search for, in the literature data set, top n entities whose text information coincidence degrees with the disputed entities exceed a preset coincidence degree threshold, score the disputed entities according to the coincidence degree and a frequency, and determine disputed entities whose scores are less than a discrimination threshold as incorrect entities.

10. The system for identifying an entity tagging error of a knowledge graph on a literature data set according to claim 9, further comprising:
a tag generation module, configured to perform entity tagging on the literature data set composed of collected literature data in a specific field, specifically comprising:
cutting an entire article into text fragments with a length less than 256 characters, and manually performing entity tagging on each text fragment by using a BIO tagging method.
